(19) United States
(12) Patent Application Publication
(10) Pub. No.: US 2009/0065976 A1
(43) Pub. Date: Mar. 12, 2009

(54) COMPONENT PART WITH INTEGRATED SEAL

(76) Inventors: Ralf SALAMEH, Gondelsheim (DE); Timo WALZ, Gondelsheim (DE)

Correspondence Address: Robert L. Stearns;Dickinson Wright PLLC, 38525 Woodward Avenue, Bloomfield Hills, MI, 48304, US

(21) Appl. No.: 12/273,145

(22) Filed: Nov. 18, 2008

Related U.S. Application Data
(62) Division of application No. 11/181,142, filed on Jul. 14, 2005.

(30) Foreign Application Priority Data
Jul. 15, 2004 (DE) 10 2004 034 235.0

(51) Int. Cl. B29C 45/14

(52) U.S. Cl. 264/265

(57) ABSTRACT

A lid component part of an internal combustion engine with integrated elastic seal, such as, for example, is provided to a cylinder head gasket or oil pan and a process for its manufacture. The component part exhibits a circumferential flange area for the arranging of the integrated seal. The component part is based on a plastic-material, while the seal essentially comprises an organic elastomer material. The component part and the seal are chemically bonded with one another. The seal is applied by injection molding onto the component part.

This is a divisional application which claims priority to German Patent Application No. 10 2004 034 235.0, filed Jul. 15, 2004 and U.S. patent application Ser. No. 11/181,142, filed Jul. 14, 2005.

### BACKGROUND OF THE INVENTION

1. Technical Field

The present invention relates to an elastic seal for the static sealing of plastic components in the field of internal combustion engines, for example, existing cylinder head gaskets made from plastic. In particular, the present invention concerns an integrated seal with a component part of this type.

2. Related Art

Thin-walled lids for internal combustion engines, such as, for example, valve covers or cylinder head gaskets include elastic seals for static sealing. The known seals are, as a rule, buttoned-in or vulcanized directly at the cylinder head gasket. With the vulcanized seals, the elastomer either is injected into an available groove and mechanically clamped (DE 42 02 860) or clamped in closed form (DE 197 38 275) or joined by an adhesive to the surface (GB 12 63 077).

In the field of internal combustion engines there is, however, an increasing need at present for seals which are joined firmly with sealing component parts. Integrated seals of this kind have the advantage, that larger system components can be delivered prefabricated in a so-called module. The joining or, respectively, integration of seal and component part and lid demonstrates strong technical advantages such as the form stability of the seal, advantageous handling during production and assembly, etc. Typical component parts to which the seals are directly injection molded in order for the joining of component parts and seals to be achieved mainly comprise component parts such as, for example, cylinder head gaskets or oil pans made from die-cast metal or steel sheets. For directly injection-molded seals of this kind, an adhesive agent is conventionally used which brings about the necessary binding of between metal and (die-cast or (steel-) sheet) and seal.

### SUMMARY OF THE INVENTION AND ADVANTAGES

Component parts made from plastic, which are distinguished, above all, by their lower density make up in increasing mass for their counterparts of metal providing that a weight reduction is obtained, which directly favorably affects the fuel consumption of the internal combustion engine. Up to now, directly injected seals of this type of existing plastic component parts of internal combustion engines are not in use.

It is an object of the invention to make available with a directly injection-molded seal a component part made from existing plastic. In particular, it is an object of the invention to provide by direct injection molding an existing cylinder head gasket made from plastic or, respectively, an integrated seal.

The problem is solved according to the present invention by providing a lid component part of an internal combustion machine with integrated elastic seal, as for example, a cylinder head gasket or oil pan. The component part exhibits a circular flange area for the structuring of the integrated seal. The component part is based on a plastic-material, while the seal is formed substantially from an organic elastomer material. The component part and the seal are chemically bound with one another.

In accordance with the invention the flange area is formed substantially in an L-shape, so that the seal is arranged with its sealing profiled element on a seal surface of the surface area. Furthermore, the seal encompasses the lateral flange area, so that the seal is at least partially arranged on the upper flange surface.

Preferably the component part is prepared from polyamide. Advantageously, the elastomer material of the seal exhibits a Mooney-viscosity ML (1+4) at 100° C. in a range of about 20 to 100 and particularly in a range of about 25 to 50. Especially, the organic elastomer material is a rubber such as, for example, a fluorinated rubber or an acrylate rubber. Preferred are organic elastomer materials from polyacrylate (ACM) or ethylene acrylate (AEM). Advantageously, a crosslinking system of organic elastomers is based on hexamethylenediaminecarbamate or N,N′-di-ortho-tolylguanidine. According to the invention, the chemical binding between the component part and the organic elastomer material of the seal can be effected by an adhesive.

Preferably, the component part is formed of thin-walls.

In accordance with the invention, the flange area can display one or more passages, with which the organic elastomer materials of the seal are filled, so that a part of the seal arranged on the seal surface is mechanically capable of coupling with a part of the seal arranged on the upper flange surface. Furthermore, according to the invention the component part possesses one or more blocking structures, which are encompassed by the seal.

Preferably, the seal is applied by means of injection molding upon the component part.

In accordance with the invention, a method is provided in order for a lid component part with integrated elastic seal of an internal combustion engine to be manufactured, such as for example, a cylinder head gasket or oil pan. The component part with a circular flange area for the disposition of the seal is provided and the existing seal made from an organic elastomer material is applied by means of a pick tool. The component part and the seal undergo a chemical bonding with one another.

Preferably, the pick tool is so formed that the resulting seal with its seal gasket is arranged on a seal surface of the surface area, and encompasses the lateral flange area, so that the seal is at least partially arranged on the upper flange surface. For this, the flange area is formed substantially in L-shape. Furthermore, the component part can be provided preheated at a temperature in a range from about 100° C. to 150° C.

### THE DRAWINGS

The invention is more closely explained by means of the following exemplary drawings which refer to a specific embodiment of the invention. The drawings show:

FIG. 1 a first schematic perspective sectional view of a component part with integrated seal according to a specific embodiment of the invention;

FIG. 2 a second schematic perspective sectional view of the component part according to FIG. 1 with screw connection point; and

FIG. 3 a third schematic perspective sectional view of the component part according to FIGS. 1 and 2 with screw connection point and aspect on the seal gasket.

### DETAILED DESCRIPTION

In the figures, as well as in the description, the same reference numerals are used, in order to designate the same or similar component parts or elements.

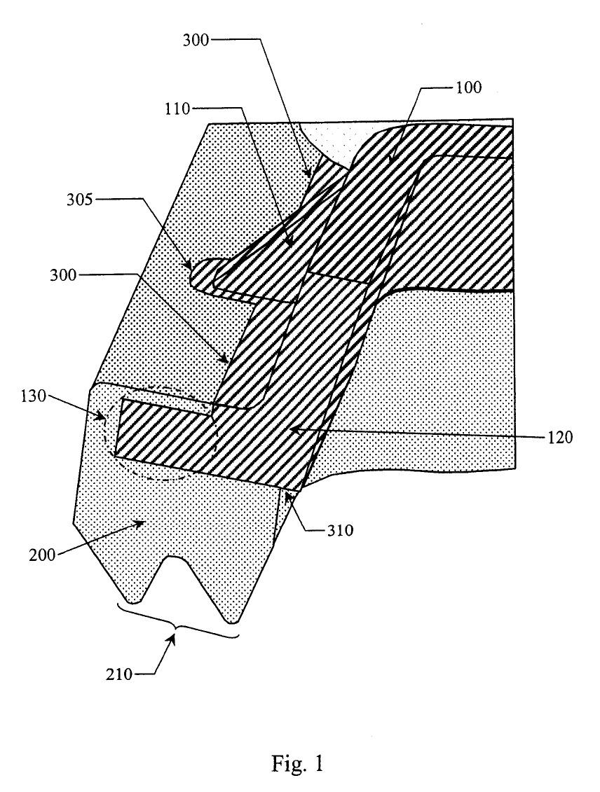

By reference to FIG. 1 an existing plastic component part of an internal combustion engine with an integrated seal according to a specific embodiment of the invention is explained by example. The displayed component part frame of FIG. 1 could concretely be a lid, a cylinder head gasket, an oil pan or the like. The integrated seal equipped component part is designated in general as 100 in the figures, while the injection molded seal, which in this embodiment is set out by example as a double-lipped seal, is designated as 200 in the figures. The sealing profiled element of the double-lip seal is named as 210 in the figures.

Of course, sealing profile elements with a seal lip or several seal lips are possible.

The component part 100, that is exemplicative of the lid, the cylinder head gasket, the oil pan, etc. is prepared as described above from plastic, preferably made out of polyamide. Elastomers are used as sealing substances, especially preferred are selected organic elastomers but no conventional inorganic elastomers such as, for example, silicone are used. From the domain of the organic elastomers, above all, rubbers such as, for example, fluorinated rubber (FPM), acrylate-rubber, polyacrylate-acrylic resin, polyacrylate (ACM) ethylene acrylate (AEM) are used. For the injection process, among other things, the viscosity of the useful organic elastomers and particularly the Mooney-viscosity, that is, a measure of the sheer viscosity, is to be considered. According to material choice and Shore A hardness the Mooney-viscosity ML (1+4) of the organic elastomers, measured at 100° C., cost-effectively should lie in a range from about 20 to 100. In order for a chemical bonding between the existing plastic component parts and the injected seal made from AEM or ACM to be ensured, the Mooney-viscosity (ML (1+4) at 100° C.) with this choice of materials should be in the range of about 25 to 50.

The bonding of the plastic component parts and seal made from elastomer can result through direct adhesion joining together of the materials or with the aid of an additionally supplied adhesive. Alternatively, the plastic of the component part and/or the elastomer can be modified, in order to enable the adhesion, in the form for example, of a chemical bond.

Moreover, for a chemical bond between component part and injection-molded seal, preferably a suitable crosslinking system of the elastomers is to be chosen, which enters into chemically compatible and suitable chemical bonding. For an existing polyamide component part the crosslinking system would be designed on the basis of hexamethylene diamine carbamate and N,N′-Di-ortho-tolylguanidine, in order to insure the chemical bonding of the polyamide with the elastomer.

A good chemical bond between the plastic component part and the injection-molded seal is additionally guaranteed preferably by preheating of the component part. Conveniently, the component part I heated to a temperature in the range of about 100° C. to 150° C. before the injection of the seal, that is, before the injection process.

In conclusion, it is to be noted that the combination of plastic of the component part and elastomer of the seal, is provided for integration with the component part, the requirements of the use environment having to be satisfied. That is, the requirements among others, are determined for the selection of the material and/or elastomers. In particular, temperature demands, creep effects of the material (component part materials, seal-materials) and stiffness are to be taken into consideration. Also to be considered is the combined effect of the component part with the other component part, against which the sealing should take place or against whose surface the sealing should occur. Particularly of interest in this connection are variable physical properties of the materials used for the component parts in this connection. Therefore, the existing-plastic, integrated seal-equipped component part seals against a component part manufactured from metal, whereby the physical properties particularly in respect to the temperature-contingent varying expansion-properties and varying rigidity properties, are to be taken into consideration.

In combination with the above-described chemical bonding of the injection-molded seal based upon an organic elastomer to the component part made from plastic, an advantageous novel geometry of the component part with integrated seal is proposed within the scope of the present invention. The novel geometry concerns the flange area of the component part, in which the integrated seal is arranged. By reference to FIG. 1 in the perspective sectional view, a cross-sectional surface 120 of the component part is shown. The flange area of the component part is formed with a generally L-shaped projection towards periphery, i.e. the flange surface is generally L-shaped. The projection is characterized in general as 130 in the figures.

The flange area has a lower flange surface, also designated in the following as a sealing profile element, which in the assembled state of the component part is directed in line to a seal opposite surface of an opposite or counter component part (not shown) and an upper flange surface which is arranged parallel to the lower surface and is directed in the assembled state path of seal opposite surface of the opposite or counter component part.

The seal is wrapped around the flange surface. This means that the seal, whose seal element profile is arranged out of the seal element profile surface, laterally encompasses towards periphery the L-shaped protrusion of the flange surface, so that a lateral flange surface of the L-shaped protrusion of the surface area of the seal is covered, and is arranged at least partially overlapping the upper flange surface of the L-shaped protrusion of the surface area. On the upper flange surface a sealing-off edge 300 is provided, up to which the elastomer-material of the seal is led and with which the seal preferably terminates flatly upwards there. Furthermore, the seal also displays a sealing edge 310, on which the arranged sealing element profile runs.

That the seal laterally encompasses the flange area also has the advantage, that the seal or, respectively, the seal element profile can be arranged more in line to the lateral edge of the component part, so that the flange area can be better utilized. This is not the case, if the seal had been completely arranged on the sealing element profile surface or, respectively, on the lower flange surface and had been imprinted there accordingly on both sides. In the proposed geometry of the invention, the seal is only one-sided, and the lateral opposite edge is imprinted.

The tool or the pointed tool for the deployment of the injected seal with the above-described seal geometry is provided with imprinted areas in correspondence with the sealing-off edge 300 on the upper flange surface and a sealing edge 310 on the lower flange surface or, respectively, the sealing element profile surface. In the imprint areas the tool seals off during the injection processes against the component part, so the seal geometry explained above, which provides an encirclement of the surface area, is obtained.

For the mechanical reinforcement of plastic component parts, as they are discussed here, often additional reinforcement ribs 110 or other reinforcement structures of equal function are inserted, in order to strengthen the flange area of the component part, and to ensure and/or to improve the sealing effect of the seal. Exemplarily, a reinforcement rib 110 is illustrated in FIG. 1. The encompassing or encircling seal encompasses the flange or encircles the reinforcement rib 110, which also is encircled by a sealing-off edge 305, which stands in connection with sealing-off edge 300.

The above-explained tool or pointed tool is adjusted in correspondence with the course of the sealing-off edges 300 and 305, in order to enable the above explained encirclement of the reinforcement ribs 110, or respectively, the reinforcement structures by means of the seal geometry.

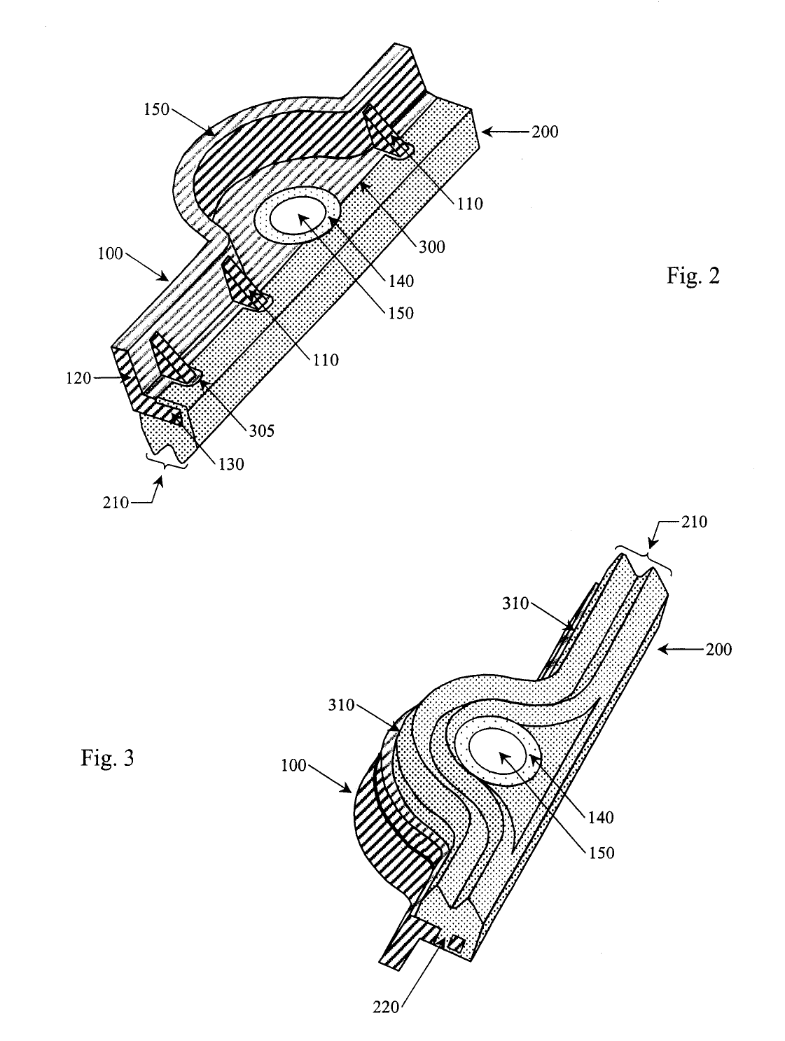

FIG. 2 shows a second schematic perspective sectional view of the component part corresponding to the specific embodiment illustrated in FIG. 1. The sectional view displayed in FIG. 2 shows in essence a top view on the upper flange surface and a specified screw point 150 in the component part to this assembly.

For exemplary illustration the component part with three reinforcement ribs 110 is provided, which shows in each case a sealing-off edge (305) adjusted to the geometry of the reinforcement ribs 110 and is encompassed by the seal as described above.

The screwing point 150 shows exemplarily a possibility, to provide an eye area or an implementation, by means of which the component part can be fastened to the counter component part. Advantageously, the screwing point 150 serves for the leading through of a screw which is screwed into the counter component part, in order for the component part with the sealing element profile of the seal to be fixed against the counter component part. For the fixation, a predetermined jacking force is usually set. For mechanical stabilization and/or reinforcement, such a screwing point 150 can be provided with a reinforcement 140 such as, for example, a hollow shaft, which preferably can be manufactured from a plastic or metal material. Such grommets or screwing points 150 are advantageously arranged substantially in the flange area, so that the predetermined jacking force, which is created by the fixation of the component part by means of the screwing points 150, directly acts as much as possible on the seal or the sealing element profile.

In addition, with implementations of this kind (or, respectively, screwing points 150) decoupling elements for acoustic decoupling of the component part of the counter component part and/or separator can be provided. The decoupling elements or, respectively, the separator thereby can be injected together with the seal or be formed from one other material with contingent differing Shore A hardness. The decoupling element or, respectively, the separator can subsequently also be provided integrated.

In conclusion, FIG. 3 shows a third schematic perspective sectional view of the component part corresponding to the specific embodiment illustrated in FIG. 1 or 2.

The sectional view displayed in FIG. 3 shows in essence a top view on the sealing element profile, i.e. the lower flange surface, and the screwing point 150 with hollow shaft 140.

In the perspective sectional view of FIG. 3 the double-lipped profile of the seal is clearly recognizable. The seal is led around in the area of the screwing point 150 around the screwing point 150 with hollow shaft 140. With sufficient space the seal is conducted around as seal lips. However, alternatively it is also possible, at points of constriction, particularly in the area of screwing points, such as the screwing point 150 to bring together the sealing element profile in the form of double lips, so that at least area-wise the sealing element profile is implemented as single lip. Equivalents are also certainly valid for multi-lipped embodiments of the sealing element profile, which can be brought together to double-lips at constriction points in reduced number.

Advantageously, the flange surface is provided with additional pathway 220. Such pathways can be filled, for example, during the injection process for the combination of the seal with the elastomer, so that an immediate coupling of the applied seal on the upper flange surface and the applied seal on the lower flange surface is obtained, which effects a stabilization of the seal geometry supplementary to the bonding of seal and component part. Alternatively, a mechanical fixation of the seal in the above-described action can also be obtained by means of an additional fixation element, which intervenes in the pathway 220 or takes vigorous action through the pathway 220.

1. A process for manufacturing of a lid component part of an internal combustion engine with integrated elastic seal, comprising:
providing of the component part with a circumferential flange area for the arranging of the seal,
providing an organic elastomer-material with a crosslinking system; and
injecting the elastomeric substance by a pointed tool, wherein the seal is formed from the organic elastomer-material, wherein the component part and the seal undergo a chemical bonding directly with one another without the assistance of an adhesive.

2. The process according to claim 1, wherein the pointed tool is constructed, so that the resulting seal is arranged with its sealing element profile on a sealing surface of the surface region and laterally intervenes the flange area, so that the seal at least partially is arranged on the upper flange surface, whereby the flange region is formed essentially L-shaped.

3. The process according to claim 1, wherein the component part is preheated to a temperature in a range from about 100° C. to 150° C.
